(19) United States
(12) Patent Application Publication
(10) Pub. No.: US 2010/0040451 A1
(43) Pub. Date: Feb. 18, 2010

(54) INTERMEDIATE STORAGE DEVICE AND STACKING UNIT WITH INTERMEDIATE STORAGE DEVICE

(75) Inventor: Roman Dax, Barctswil (CH)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Ferag AG

(21) Appl. No.: 12/541,746

(22) Filed: Aug. 14, 2009

(30) Foreign Application Priority Data
Aug. 18, 2008 (CH) CH2008 01306/08

(51) Int. Cl. B65G 37/00; B65G 49/00; B65G 15/28; B65G 57/00

(52) U.S. Cl. 414/789.9; 198/644; 198/577; 198/617; 414/802

(57) ABSTRACT

The intermediate storage device (18) for taking stacks (14) of flat products (16) from a supplying device (10) connected upstream, for storing the stacks (14) in a temporary manner and for the subsequent delivery of the stacks (14) to a stack processing device (20) connected downstream, has at least one conveying means (36) with an upper run (34), which is displaceable in a conveying direction (T) and on which, for conveying the stack (14), a bottommost flat product (16u) of the stack (14) rests at least in a partial manner. The intermediate storage device (18) has, in addition, a control device (68), which generates a signal for controlling a conveying speed of the conveying means (36). According to the invention, the control device (68) is capable of receiving a control signal from the supplying device (10) connected upstream and an additional control signal from the stack processing device (20) connected downstream and, in dependence on the control signal and on the additional control signal, is capable of controlling the conveying speed of the conveying means (36) adapting it to the pulsing of the supplying device (10) and of the stack processing device (20).

### BACKGROUND OF THE INVENTION

The present invention relates to an intermediate storage device as claimed in the preamble of claim 1, a stacking unit with such an intermediate storage device as claimed in claim 9 and a method for operating the intermediate storage device as claimed in claim 13.

An intermediate storage device in terms of the present invention refers to a device for taking, temporarily storing and conveying stacks of flat products, in particular printed products. Along with such an intermediate storage device, a stacking unit also includes a stacking device connected upstream for forming a stack of flat products.

A device for the controlled conveying of stacks of printed products lying one on top of the other is known, for example, in EP 1 273 542. The device, in this case, has a conveying-effecting traction means circulating about two deflecting rollers, by means of which stacks resting thereon are able to be conveyed. Support bars hold the stacks upright and in constant form. A conveying-effecting region of the traction means is slanted and ends at the level of a horizontally oriented guide table. The conveying speed of the stack can be slowed or controlled by means of a control device.

### BRIEF SUMMARY OF THE INVENTION

It is the object of the present invention to optimize a stack processing sequence between a supplying device, in particular a stacking device, and a stack processing device, which have different processing speeds or pulsings.

This object is achieved by an intermediate storage device as claimed in claim 1, a stacking unit with such an intermediate storage device as claimed in claim 9 and a method for operating the intermediate storage device as claimed in claim 13.

The intermediate storage device according to the invention, which is positioned between a supplying device connected upstream for preparing stacks of flat products, in particular printed products, and a stack processing device connected downstream for processing the stack, and the method according to the invention for operation of the same make it possible to take, store temporarily and deliver the stacks from or to the nearby device in a pulse-adapted manner. To this end, the intermediate storage device is provided with at least one conveying means, which has an upper run that is displaceable in a conveying direction, and on which, for conveying the stack, a bottommost flat product of the stack rests at least in a partial manner. In addition, the intermediate storage device has a control device that can generate a signal for controlling a conveying speed of the conveying means,

According to the invention the control device is capable of receiving a control signal from the supplying device connected upstream and an additional control signal from the stack processing device connected downstream and, in dependence on the control signal and on the additional control signal, is capable of controlling the conveying speed of the conveying means, adapting it to the pulsing of the supplying device and of the stack processing device. In this case, the ability to receive the control signals is provided by a functional, preferably electric connection between the transmitters of the control signals, that is the supplying device and the stack processing device, and the receiver, that is the control device of the intermediate storage device. The ability also includes the control device being able to interpret and process the control signals.

Through the ability of the intermediate storage device to communicate with the supplying device connected upstream and the stack processing device connected downstream, the stacks can be taken, temporarily stored and delivered in each case in a manner that is adapted to the pulsing of the intermediate storage device and of the supplying device each time at an optimally coordinated conveying speed. In this way, it is possible to adapt, for example, the pulsing of a stack processing device with a fairly long processing time to a supplying device, in particular a stacking device, with a quicker processing time. By adapting the pulsing and conveying speed, including the possibility of a static intermediate storage of stacks, the stack processing sequences are optimized in terms of reduced cycle times or higher processing rates.

In a particularly preferred specific embodiment, the control device, when the intermediate storage device is occupied, is also capable of sending a backlog signal to a stack controlling device of a stacking device that is in the form of a supplying device. The stack controlling device is designed in such a manner that, when it receives a backlog signal, it can direct the stacking device to adapt in a corresponding manner, in particular to increase, the number of flat products for the stack to be formed. Thus, for example, it is possible to prefer the forming of stacks with a greater number of flat products in the stack forming sequence. In this way it is possible to utilize, in an optimum manner, the time in which the intermediate storage device is still occupied with a stack, to form, where applicable, larger stacks with a greater number of flat products that are subsequently necessary. Consequently, it is ensured that the stacking device, as a rule operated at a higher stacking pulse than a stack processing device, can form stacks, where applicable also stacks of different heights, in an almost continuous manner with interruptions that are as short as possible, and does not have to be adapted directly to the generally slower pulsing of the stack processing device. This results in a further optimized stack processing sequence and in shorter cycle times or higher stack processing rates.

The stacking unit according to the invention, along with the intermediate storage device according to the invention for taking, temporarily storing and conveying stacks, comprises a stacking device connected upstream for forming the stack from flat products.

Particularly preferred specific embodiments of the intermediate storage device, the stacking unit and the method for operating the intermediate storage device are provided with features detailed in the dependent claims.

### BRIEF DESCRIPTION OF THE SEVERAL VIEWS OF THE DRAWINGS

Two particularly preferred specific embodiments of the present invention are described below by way of drawings in which, in detail, in a purely schematic manner:

FIG. 1 shows a top view of a stacking unit according to the invention with a stacking device and an intermediate storage device connected downstream, which has a conveying means in order to take stacks of flat objects from the stacking device, to store them temporarily and to deliver them at a stack processing device connected downstream of the intermediate storage device;

FIG. 2 shows a view in the conveying direction of the intermediate storage device according to the invention shown in FIG. 1;

FIG. 3 shows a top view of another specific embodiment of the stacking unit according to the invention with an intermediate storage device that has a first and a second conveying means;

FIG. 4 shows, as an example, a side view of a cycle of stacks of different heights formed in the stacking device; and

FIG. 5 shows, as an example, a speed/time diagram of a stack processing sequence of the stacking unit shown in FIG. 3.

### DETAILED DESCRIPTION OF THE INVENTION

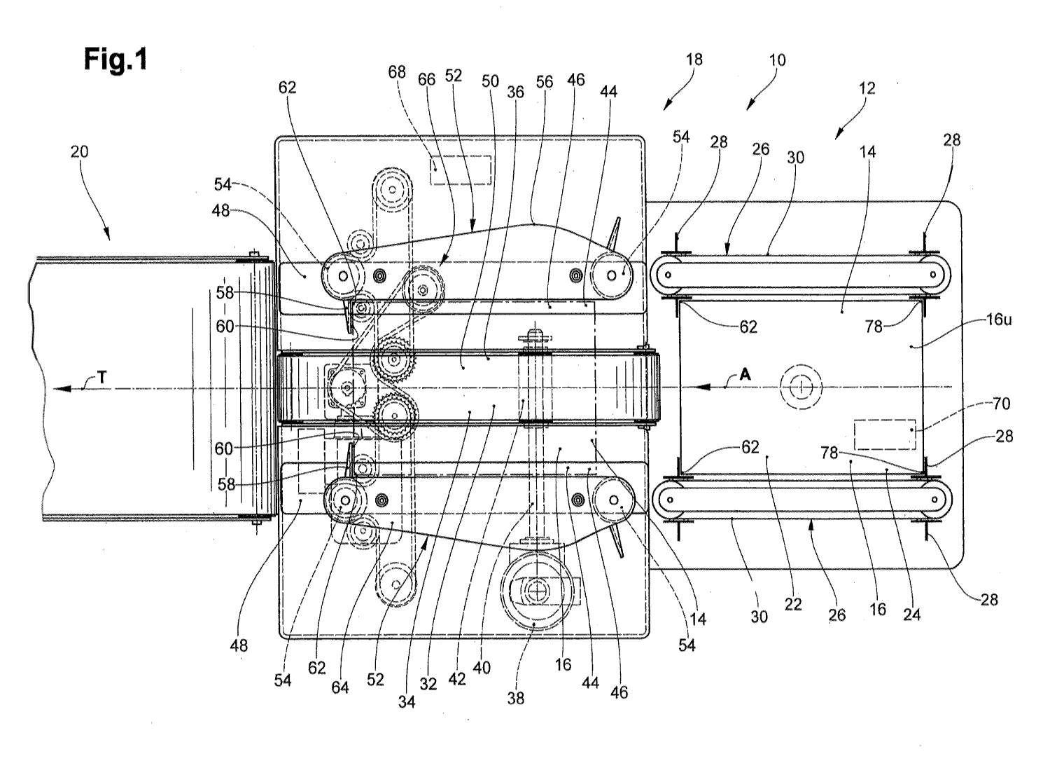

The stacking unit 10 according to the invention shown in FIG. 1 is provided with a supplying device in the form of a stacking device 12 for forming a stack 14 of flat products 16, in particular printed products, and an intermediate storage device 18 connected downstream for taking, temporarily storing and delivering the stack 14. The stack 14 is delivered or conveyed from the intermediate storage device 18 to a stack processing device 20 connected downstream, for example realized as a strapping device, a belt conveyor, a coating device etc.

The stacking device 12 has a pallet 22 for supporting the flat products 16 and two oppositely situated ejectors 26 defining a stack shaft 24. The stack shaft 24, in this case, is defined at least partially on the support side by the pallet 22 and at each corner by ejector elements 28 that are angular in cross-section. In this case, each ejector 26 has four ejector elements 28 which are positioned so as to be able to rotate at two strip-shaped drive members 30 that are each displaceable independently of each other and two of which, in each case, are situated diametrically opposite each other. A stacking device 12 of this type in the form of a rotary lifting table is described for example in EP 1 445 224.

As soon as a predetermined number of flat products 16 have come to lie one on top of the other in the stack shaft 24 of the stacking device 12 for forming the stack 14, the stack 14 is pushed by means of the ejector elements 28 of the ejector 26 in an ejection direction A out of the stacking device 12 in the direction of the intermediate storage device 18 over the pallet 12.

In this case, a bottommost flat product 16u of the stack 14 is supported at least partially on a support surface 32 of an upper run 34 of a conveying means 36 associated with the intermediate storage device 18. The conveying means 36 is, for example, formed by a belt conveyor or a chain conveyor. The conveying means 36, which is driveable by an electric drive motor 38 via a drive axle 40 and a driving roll 42 positioned thereon in a non-rotatable manner, in this case, is orientated in such a manner that a conveying direction T defined by the direction of movement of the upper run 34 of the conveying means 36 extends parallel to the ejection direction A.

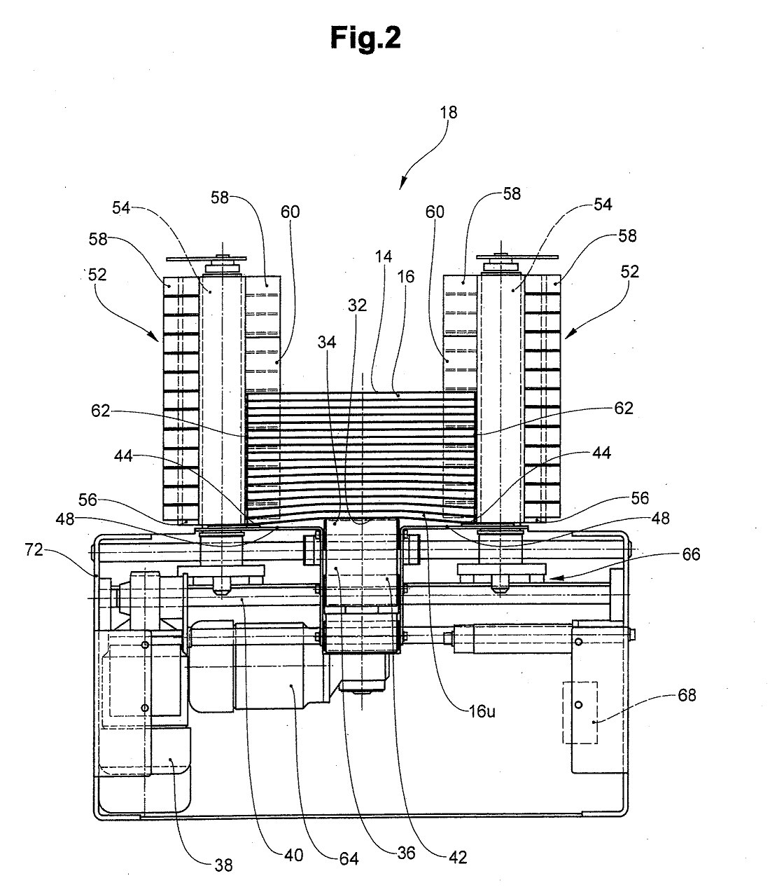

When the stack 14, ejected by the stacking device 12, is taken by the intermediate storage device 18, a longitudinal centre section of the bottommost flat product 16u is supported on the support surface 32, whilst, with reference to the conveying direction T, the outer edge regions 44 of the bottommost flat product 16u slide on sliding faces 46 of sliding plates 48 positioned on both sides of the conveying means 36. The support surface 32 of the upper run 34 of the conveying means 36, in this case, is orientated in its height in such a manner that, in the unloaded state, it extends substantially at the height of a stack contact plane 50 that is defined by the pallet 22. The sliding faces 56, when viewed in a vertical manner, extend at a small distance below the support surface 32 such that when the stack 14 is supported on the conveying means 36, it has a slight roof-shaped bulge, as can be seen in FIG. 2. This bulge in the stack 14 contributes to the stability of shape of the stack 14 as it is being conveyed by the conveying means 36.

With reference to the conveying direction T, two stop devices 52 are positioned on both sides of the conveying means 36 above the slide plates 48. The stop devices 52 each have two rotatably mounted hollow cylinders 54, which are spaced apart in the conveying direction T and are substantially vertically orientated for driving a chain belt 56 that is produced from plastics material. Stop elements 58, which are situated diametrically opposite one another, are secured in each case to the chain belt 56, said stop elements having substantially vertically orientated, planar stopping faces 60 for supporting front side edges 62 of the stack 14 advancing in the conveying direction. The stop elements 58 serve to stabilize the shape of the stack 14 when it is being conveyed in the intermediate storage device 18. The hollow cylinders 54 of the stop devices 52 of the stack processing device are each driven synchronously with one another via a servomotor 64 with a belt drive or chain drive 66 installed downstream, whereas the hollow cylinders 54 of the stacking device are each entrained with the chain belt 56. To adapt to different formats of flat products 16, it is possible to move the stop devices towards one another and away from one another as a result of elongate holes (not shown).

Control of the servomotor 64 and of the stop elements 58 driven thereby and of the drive motor 38 for influencing the conveying speed of the conveying means 36 is effected by means of a control device 68 of the intermediate storage device 18. This preferably electrically designed control device 68 is capable of receiving a control signal from the stacking device 10 connected upstream and an additional control signal from the stack processing device 20 connected downstream and, in dependence on the control signal and on the additional control signal, is capable of controlling the conveying speed of the conveying means 36, for taking, storing temporarily and delivering of the stack 14, adapting it to the pulsing of the supplying device 10 and of the stack processing device 20.

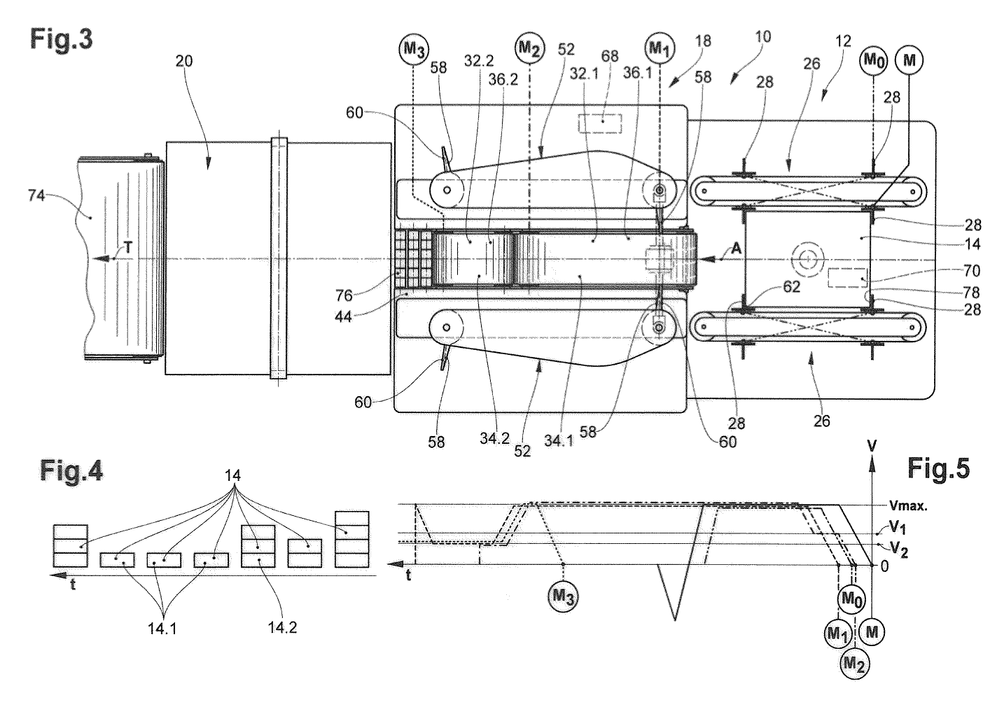

Over and above this, when the intermediate storage device 18 is occupied by a stack 14, the control device 68 can send a backlog signal to a stack controlling device 70 of the stacking device 12 that is capable of receiving said signal. As is explained in more detail below in conjunction with FIGS. 3 to 5, this can result in the stacking device being directed to form additional stacks or further stacks 14 of flat products in the stack shaft 24 preferably lying crosswise one on top of the other above said stack 14, as long as this backlog signal is receivable. Thus it is possible to prefer the forming of larger stacks 14 with a higher number of flat products and to ensure as continuous a stack forming process as possible or a stack forming process with only short-term interruptions.

In particular the exchange of electrical signals between the stack controlling device 70, which also controls the driving members 30 and consequently the movement of the ejecting elements 28, and the control device 68, which influences the conveying speed of the conveying means 36, means that they are coordinated and tuned to each other in such a way that a stack processing sequence is carried out in a pulse-optimized manner when the stack 14 is ejected from the stacking device 12 and the stack 14 is taken by the intermediate storage device 18. Along with a physically separate arrangement of the control device 68 and the stack controlling device 70, it is naturally also possible to integrate the two control devices 68, 70 spatially. Through the exchange of control signals, along with controlling the conveying speed of the conveying means 36, it is also possible for the purposes of adapting the pulsing to bring said conveying speed in line with the ejecting speed of the stacking device 12 and the taking speed of the stack processing device 20. A conveying speed harmonized in this manner is especially indispensable when ensuring the integrity and shape stability of the stack 14 when it is being conveyed.

In the view of the intermediate storage device 18 according to the invention in FIG. 2, a machine frame 72 of the intermediate storage device 18 can clearly be seen. The machine frame 72 functions as a basic supporting member for all elements of the intermediate storage device 18. It should be mentioned at this point that by means of elongate holes (not shown) in the machine frame 72, the stop devices 52 can be moved towards one another or away from one another at right angles to the conveying direction so as to adapt to the formats of the flat products 16.

FIG. 3 shows an intermediate storage device 18 or another specific embodiment of the stacking unit 10 according to the invention. Functionally and structurally identical elements in FIG. 3 are provided with the identical references to those used in FIG. 1. This specific embodiment of the stacking unit 10 according to the invention also includes a stacking device 12 and an intermediate storage device 18 which is connected downstream and, in its turn, has a stack processing device 20 connected downstream of it. In the specific embodiment shown in FIG. 3, a belt conveyor 74 for the removal of the processed stacks 14 connects to the stack processing device 20, for example a strapping device, a belt conveyor or a coating device etc.

In contrast to the intermediate storage device 18 shown in FIG. 1, in place of a conveying means 36 at the stacking device end, the intermediate storage device shown in FIG. 3 has a first conveying means 36.1 and at the stack processing device end a second conveying means 36.2. The stacks 14, during their stay in the intermediate storage device 18, lie either separately on a first support surface 32.1 of a first upper run 34.1 of the first conveying means 36.1 or on a second support surface 32.2 of a second upper run 34.2 of the second conveying means 36.2 or on both support surfaces 32,1, 32.2 at the same time with the longitudinal center region of the bottommost flat product 16u. The second conveying means 36.2, when viewed in the conveying direction T, is arranged ahead of the first conveying means 36.1 and a longitudinal center axis of the first upper run 34.1 extends coaxially to an additional longitudinal center axis of the second upper run 34.2. The conveying means 36.1, 36.2 are formed, in their turn, by belt conveyors or chain conveyors.

As mentioned for the intermediate storage device 18 in conjunction with FIG. 1, in this case too the outer end regions 44 of the bottommost flat product 16u slide on sliding faces 46 of the sliding plates 48 that are positioned on both sides of the first and second conveying means 36.1, 36.2. Stop devices 52 with the aforedescribed function and provision are also provided above the sliding plates 48.

The two conveying means 36.1, 36.2 are driven independently from one another preferably by asynchronous motors. The control device 68 of the intermediate storage device 18, along with the features already mentioned above in conjunction with FIG. 1, has the possibility of generating a signal for controlling the first conveying means 36.1 independently of an additional signal for controlling the second conveying means 36.2. In this way, it is possible, for example, to control the conveying speed of the first conveying means 36.1 in dependence on the control signal from the stacking device 12, serving as a supply station connected upstream, and the conveying speed of the second conveying means 36.2 in dependence on an additional control signal from the stack processing device 20 connected downstream. In other words, by it being possible to influence the conveying speeds independently of one another, it is possible to adapt them to the ejecting speed or taking speed of the respective adjacent device. In addition, a stack 14 can be taken by the stacking device 12 by means of the first conveying means 36.1 and at the same time an additional stack 14 can be delivered to the stack processing device 20 by means of the second conveying means 36.2.

It must be mentioned at this point that certain regions of the conveying path of the stacks 14 in the intermediate storage device 18 can be provided with passively entrained rollers 76, as they are shown, for example, at the stack processing device end in the intermediate storage device 18 in FIG. 3. Over and above this, it is naturally possible to extend the intermediate storage device 18 in the conveying direction T and, where applicable, to provide it with more conveying means so that a greater number of stacks 14 can be stored in a temporary manner.

In each case, the stack contact plane 50 of the stacking device 12, at least at the intermediate storage device end, is positioned substantially at the height of the first support surface 32.1 of the first upper run 34.1 and a stack processing plane of the stack processing device 20, at least at the intermediate storage device end, is positioned substantially at the height, at the stack processing device end, of the sliding faces 46. In addition, the first support surface 32.1 of the first conveying means 36.1 and the second support surface 32.2 of the second conveying means 36.2 extend substantially in a common plane that preferably extends horizontally.

As has already been explained in conjunction with FIG. 1, by means of the transmission of the backlog signal by the control device 68 to the stack controlling device 70, it is possible, because of the intermediate storage device 18 still being occupied by a stack 14, to direct the stacking device 12 to deposit additional stacks, preferably in a crosswise manner, above the already existing stack 14 in order to prefer the forming of a larger stack 14. This larger stack 14 is then delivered to the intermediate storage device 18 when it becomes capable of taking it.

This control behavior can lead, for example, to the varying height of the stack 14 represented schematically along the time axis t in FIG. 4. Thus for optimum pulse adaptation it can be necessary to prefer to form a larger stack 14.2, for example three times as large, in the stack forming sequence, after a sequence of three smaller stacks 14.1, the so-called top or standard packets. In this way it is possible to continue the stack forming process even with the intermediate storage device 18 occupied and to optimize the stack processing sequence. The maximum height of the stack 14 and consequently the maximum number of flat products 16 that can form the respective stack 14 is naturally determined by the stack capacity of the stacking device 12.

By way of example, a stack processing sequence of the stacking unit according to the invention is now described in conjunction with FIG. 5. To this end, the speeds of the ejector elements 28 (M—continuous line, M₀—dash dot dot line), of the first conveying means 36.1 (M₂—dash dot line), of the second conveying means 36.2 (M₃—dotted line) and of the stop elements 58 (M₁—dot dash line) are represented in the speed (v)/time (t) diagram shown.

As can be seen in the sequence diagram in FIG. 5, first of all the ejector elements 28 (M) associated with the rear side edges 78 of the stack 14 are accelerated from their idle position in an even manner to a speed vₘₐₓ, of for example 1.8 m/s, or typically also 1.4 m/s At the same time, the ejector elements 28 are moved up to the stack 14 and still during the acceleration stage, the ejector elements 28 identified by M₀ and associated with the front side edges 62 are then also set in motion. The latter, as the rearward ejector elements 28 also, are accelerated evenly up to the speed vₘₐₓ. In addition, the first conveying means 36.1 (M₀) is first of all accelerated up to a speed v₁, of for instance vₘₐₓ/2 and then further to the speed vₘₐₓ.

As soon as the stack 14 is slid onto the conveying means 36.1 that is moving at an identical speed as the stack 14, the stop elements 58 identified by M are also accelerated evenly up to the speed vₘₐₓ and then leading in front of the stack 14 are entrained at the conveying speed of the first conveying means 36.1(M₂). The advancing ejector elements 28 (M₀) then brake on the side of the ejector device 26 remote from the stack shaft 24 and move to a position for rest situated diametrically opposite the start position of the ejector elements 28 identified by M. Directly after the rearward ejector element 28 pushing out the stack 14 has reached a reversal point at the intermediate storage device end, it is also braked and initially accelerated in the opposite direction and then braked again so that it assumes the start position of the ejector element 28 associated originally with the front side edge 62 of the stack 14.

The stop elements 58(M₁) and the first conveying means 36.1(M₂), which has already been accelerated to the speed vₘₐₓ, continue moving at the speed vₘₐₓ until the stack 14 has been completely taken over. Directly before the stack 14 is taken over by the second conveying means 36.2 (M₃), its additional conveying speed is also increased from the idle state to the speed vₘₐₓ. As soon as the stack 14 is no longer resting on the first conveying means 36.1, said means, as also the leading stop elements 58 and the second conveying means 36.2, is braked evenly to a speed v₂, which is less than the speed v₁. The speed v₂ corresponds to the speed at which the following stack processing device 20 can take the stack 14. In other words, through the intermediate storage device 18, the speed vₘₐₓ at which the stack 14 is ejected from the stacking device 12 is adapted to the taking speed v₁ of the stack processing device 20.

As soon as the stop elements 58 associated with the front side edge 62 have reached their reversal point at the stack processing device end, they are accelerated again and are stopped at an end position that is situated diametrically opposite their original start position on the side remote from the conveying means 36.1, 36.2. The stop elements 58 now situated diametrically opposite at the original start position are ready for the transfer of another stack 14. Just as the stop elements 58, the first conveying means 36.1 is also braked to an idle position directly after the stack 14 has left it. The second conveying means 36.2 runs at the speed v₂ until the stack 14 has been completely transferred by the stack processing device 20.

Although the sequence diagram by way of example in FIG. 5 does not show an idle state for the stack 14 to be transported, this is naturally possible. The conveying speed of the first conveying means 36.1 and/or of the second conveying means 36.2 is reduced in this case to a complete stop. It must be pointed out at this point that whilst a stack 14 is supported on the first conveying means 36.1, the previously described backlog signal is transmitted by the control device 68 to the stack controlling device 70. In addition, it must be noted that after the ejector elements 28 have arrived at their new start position, the stacking device 12 can once again begin forming another stack 14.

As already mentioned beforehand, it is possible as soon as the stack 14 is no longer resting on the first conveying means 36.1—for the first conveying means 36.1 to take over another stack 14 from the stacking device 12. This results, along with the advantage of adapting the speed to the respectively associated stacking device 12 or stack processing device 20, in an optimized, more rapid stack processing sequence for the stacks 14, in particular also in a quicker cycle for smaller, so-called top or standard stacks, and enables stacks to be formed with any stoppages or interruptions being as short as possible.

That which is claimed:

1. An intermediate storage device which is intended to take stacks (14) of flat products (16), in particular printed products, from a supplying device (10) connected upstream, store them temporarily and deliver them to a stack processing device (20) connected downstream for processing the stack (14), said intermediate storage device having a conveying mechanism (36, 36.1) with an upper run (34, 34.1) that is displaceable in a conveying direction (T), on which, for conveying the stack (14), a bottommost flat product (16u) of the stack (14) rests at least in a partial manner, and also having a control device (68), which generates a signal for controlling a conveying speed of the conveying mechanism (36, 36.1), wherein the control device (68) is configured to receive a control signal from the supplying device (10) connected upstream and an additional control signal from the stack processing device (20) connected downstream and, in dependence on the control signal and on the additional control signal, is configured to control the conveying speed of the conveying mechanism (36, 36.1) adapting it to the pulsing of the supplying device (10) and of the stack processing device (20).

2. The intermediate storage device as claimed in claim 1, comprising at least one additional conveying mechanism (36.2) with an additional upper run (35.2), which is also displaceable in the conveying direction (T) and on which, for conveying the stack (14), the bottommost flat product (16u) of the stack (14) rests at least in a partial manner, wherein an additional conveying speed of the additional conveying mechanism (36.2), which is positioned in the conveying direction (T) offset forward in relation to the conveying mechanism (36.1), is controllable by an additional signal of the control device (68) independent of the conveying speed of the conveying mechanism (36.1) adapting it to the pulsing of the supplying device (10) and of the stack processing device (20).

3. The intermediate storage device as claimed in claim 2, wherein a support surface (32.1) of the upper run (34.1) and an additional contact support (32.2) of the additional upper run (34.2), in the respective unloaded state, rest at least virtually in a contact plane that preferably extends at least virtually horizontally.

4. The intermediate storage device as claimed in claim 2, wherein a longitudinal center axis of the upper run (34.1) of the conveying mechanism (36.1) extends in a coaxial manner to an additional longitudinal centre axis of the additional upper run (34.2) of the additional conveying mechanism (36.2).

5. The intermediate storage device as claimed in claim 1, wherein, with reference to the conveying direction (T), a sliding plate (48) is positioned in each case on both sides of the conveying mechanism (36, 36.1) and, where applicable, on both sides of the additional conveying mechanism (36.2), on the sliding faces (46) of said sliding plate in each case an edge region (44) of the bottommost flat product (16u) of the stack (14) rests at least in a partial manner, wherein the sliding faces (46) lie substantially in an at least virtually horizontal sliding plane, which extends below the contact plane.

6. The intermediate storage device as claimed in claim 1, wherein, with reference to the conveying direction (T), a stop device (52) is positioned in each case on both sides of the conveying mechanism (36.1) and, where applicable, on both sides of the additional conveying mechanism (36.2), said stop device having in each case at least one rotatably displaceable stop member (58) that is preferably driveable by mechanism of a servo motor (64), said stop member having a preferably planar contact surface (60) that is substantially vertically oriented for supporting a front side edge (62) of the stack (14) leading in the conveying direction (T).

7. The intermediate storage device as claimed in claim 6, wherein the stop devices (52) are arranged so as to be movable towards each other and movable away from each other for adapting to various formats of flat products (16).

8. The intermediate storage device as claimed in claim 1, wherein the supplying device (10) connected upstream is in the form of a stacking device (12) for forming the stack (14) of flat products (16) and the control device (68), when the intermediate storage device (18) is occupied with a stack (14), is capable of sending a backlog signal to a stack controlling device (70) of the stacking device (12) that is capable of receiving the backlog signal, on account of which the stacking device (12) can adapt, in particular can increase, the number of flat products (16) for the stack (14) to be formed.

9. A stacking unit with a stacking device (12) for forming a stack (14) of flat products (16), in particular printed products, and an intermediate storage device (18) connected downstream for taking, temporarily storing and delivering the stack (14) as claimed in one of claims 1 to 8, wherein the intermediate storage device (18) has at least one conveying mechanism (36, 36.1) and the conveying mechanism (36, 36.1) is provided with an upper run (34, 34.1), which is displaceable in the conveying direction (T) and on which, for conveying the stack (14), a bottommost flat product (16u) of the stack (14) rests at least in a partial manner, and the intermediate storage device (18) also has a control device (68), which can generate a signal for controlling a conveying speed of the conveying mechanism (36, 36.1) and is capable of receiving a control signal from the stacking device (12) connected upstream and an additional control signal from a stack processing device (20) connected downstream and, in dependence on the control signal and on the additional control signal, is capable of controlling the conveying speed of the conveying mechanism (36, 36.1) adapting it to the pulsing of the stacking device (12) and of the stack processing device (20).

10. The stacking unit as claimed in claim 9, wherein the control device (68), when the intermediate storage device (18) is occupied with a stack (14), is capable of sending a backlog signal to a stack controlling device (70) of the stacking device (12) that is capable of receiving the backlog signal, on account of which the stacking device (12) can adapt, in particular can increase, the number of flat products (16) for the stack (14) to be formed.

11. The stacking unit as claimed in claim 9, wherein the intermediate storage device (18) has at least one additional conveying mechanism (36.2) with an additional upper run (34.2), which is also displaceable in the conveying direction (T) and on which, for conveying the stack (14), the bottommost flat product (16u) of the stack (14) rests at least in a partial manner, wherein an additional conveying speed of the additional conveying mechanism (36.2) positioned in the conveying direction (T) offset forward in relation to the conveying mechanism (36.1) is controllable by an additional signal of the control device (68) independent of the conveying speed of the conveying mechanism (36.1).

12. The stacking unit as claimed in one of claims 9 to 11, wherein a stack contact plane (50) of the stacking device (12) for supporting the bottommost flat product (16u) at least one side of the intermediate storage device is positioned substantially at the level of a support surface (32, 32.1) of the conveying mechanism (36, 36.1) that is defined by the upper run (34, 34,1).

13. A method for operating an intermediate storage device, said method comprising taking a stack (14) of flat products (16) from a supplying device (10) connected upstream into the intermediate storage device (18) and delivering the stack (14) from the intermediate storage device (18) to a stack processing device (20) connected downstream for processing the stack (14), wherein the conveying speed of a conveying mechanism (36, 36.1) of the intermediate storage device (18) is determined by a signal generated by a control device (68) of the intermediate storage device (18), said signal being generated for adapting to the pulsing of the supplying device (10) and of the stack processing machine (20) in dependence on a control signal from the supplying device (10) connected upstream and on an additional control signal from the stack processing device (20) connected downstream.

14. The method as claimed in claim 13, wherein the supplying device (10) connected upstream is in the form of a stacking device (12) for forming the stack (14) and the control device (68), when the intermediate storage device (18) is occupied with a stack (14), sends a backlog signal to a stack controlling device (70) of the stacking device (12) that is capable of receiving the backlog signal, on account of which the stacking device (12) can adapt, in particular can increase, the number of flat products (16) for the stack (14) to be formed.
